(19) United States
(12) Patent Application Publication
(10) Pub. No.: US 2011/0265031 A1
(43) Pub. Date: Oct. 27, 2011

(54) Multi-layer window display system and method for real-time translation

(75) Inventors: Chaucer Chiu, Taipei (TW); Jiuying Zhao, Shanghai (CN)

(73) Assignee: INVENTEC CORPORATION, Taipei (TW)

(21) Appl. No.: 12/805,975

(22) Filed: Aug. 27, 2010

(30) Foreign Application Priority Data
Apr. 27, 2010 (TW) 099113280

(51) Int. Cl. G06F 3/048

(52) U.S. Cl. 715/790

(57) ABSTRACT

A multi-layer window display system for real-time translation and the method thereof show the contents for multiple windows in alternating directions. The user can see more contents in a limited screen. Moreover, the invention reduces user's mouse motion during the operation. Therefore, the invention has the advantages of using limited screen space to show more contents and making user's operations more convenient.

### BACKGROUND OF THE INVENTION

1. Field of Invention

The invention relates to a window display system and method and, in particular, to a multi-layer window display system for real-time translation and the method thereof.

2. Related Art

Thanks to the tremendous progress in technology in recent years, computers and Internet have become very popular. On the Internet, there are no boundaries between countries. There are chances for users to read a language that is not native to them. However, for such non-native speakers, there often are difficulties or even misunderstanding. In this case, real-time translation systems have been invented to solve the problem. The users can quickly look up words and understand their correct meanings. This greatly reduces the look-up time in comparison with traditional dictionaries.

The real-time translation system finds words entered by its user in real time. Since the search results may have a lot to show and such contents often have some hierarchical structure, they need to be displayed in different windows. In addition to presenting the contents in a specific order, it also enables the user to understand the hierarchical structure or relations. The primary display style in the prior art is shown in FIG. 1. The real-time translation system utilizes many windows to show different kinds of contents, following a certain order and hierarchical structure.

As shown in the drawing, the displayed windows in the prior art extend in one direction indefinitely. Once the number of extended windows exceeds a certain quantity, they will easily occupy the entire screen so that other application windows simultaneously used by the user or icons on the desktop are covered. Another drawback in the prior art is that in order to trigger and browse other display contents, the user has to move the mouse toward the extended direction. This increases the moving track of the mouse and becomes inconvenient.

In summary, the prior art always has the problems that the multi-layer windows of the real-time translation system often occupy too much of the screen and that the mouse operation is not convenient for the user. It is therefore necessary to provide a better solution.

### SUMMARY OF THE INVENTION

In view of the foregoing, the invention provides a multi-layer window display system for the REAL-TIME TRANSLATION SYSTEM and the method thereof. Its basic features are to show the multi-layer display contents in windows in opposite direction. The user can thus see more contents in the limited screen. Moreover, the mouse tracking motion can be reduced. Therefore, the invention makes better use of the screen space and renders more convenient operations.

The disclosed multi-layer window display system for the REAL-TIME TRANSLATION SYSTEM includes: an input module for receiving a word to search; a vocabulary database for storing at least one word and at least a corresponding layer of display contents, and for searching the input word and outputting the corresponding contents; a multi-layer window display processing module for generating an appropriate number of windows in layers when it receives at least one layer of contents, where the contents in the first layer is shown in the current window and the contents of the other layers are kept in at least one hidden window. When there is at least one hidden window, the following procedure is executed iteratively. First, the system generates at least one trigger icon for the next layer of contents in the current window. The system then detects the mouse cursor position. When the mouse cursor position is at one of the trigger icons, the contents in the next layer are shown in a window in the direction designated by the current window. The originally hidden window now becomes the current window. The system then checks whether there are any contents for the next layer. In particular, the direction designated by the current window is always opposite to the previous one.

The disclosed multi-layer window display method for the REAL-TIME TRANSLATION SYSTEM includes the steps of: searching an entered word and outputting at least one layer of contents; generating corresponding layers of windows to display the contents, where contents of the first layer are shown in a current window and the contents of the other layers are given to at least one hidden window; executing the following steps iteratively when there is at least one hidden window. First, the method generates at least one trigger icon for the next layer of contents in the current window. The method then detects the mouse cursor position. When the mouse cursor position is at one of the trigger icons, the contents in the next layer are shown in a window in the direction designated by the current window. The originally hidden window now becomes the current window. The method then checks whether there are any contents for the next layer. In particular, the direction designated by the current window is always opposite to the previous one.

In the above-mentioned system and method, the direction designated by the current window can be right or left, or up or down. When the invention is detecting the mouse cursor position, the current window is hidden when it is located outside the current window. Moreover, the trigger icons indicate the directions designated by the windows, so that the user knows in which direction the next window will be shown.

The disclosed system and method differ from the prior art in that the contents in the multi-layer windows are shown in windows in alternating directions. The user is thus able to see more contents in a limited screen. Moreover, the user's mouse tracking motion can be reduced. Therefore, the invention makes better use of the screen space and renders more convenient operations.

### BRIEF DESCRIPTION OF THE DRAWINGS

The invention will become more fully understood from the detailed description given herein below illustration only, and thus is not limitative of the present invention, and wherein:

FIG. 1 shows the prior art;

FIG. 2 is a system block diagram of the multi-layer window display system for the REAL-TIME TRANSLATION SYSTEM according to the invention;

FIG. 3 is a flowchart of the multi-layer window display system for the REAL-TIME TRANSLATION SYSTEM according to the invention; and

FIGS. 4A to 4D provide an embodiment of the disclosed multi-layer window display system for the REAL-TIME TRANSLATION SYSTEM.

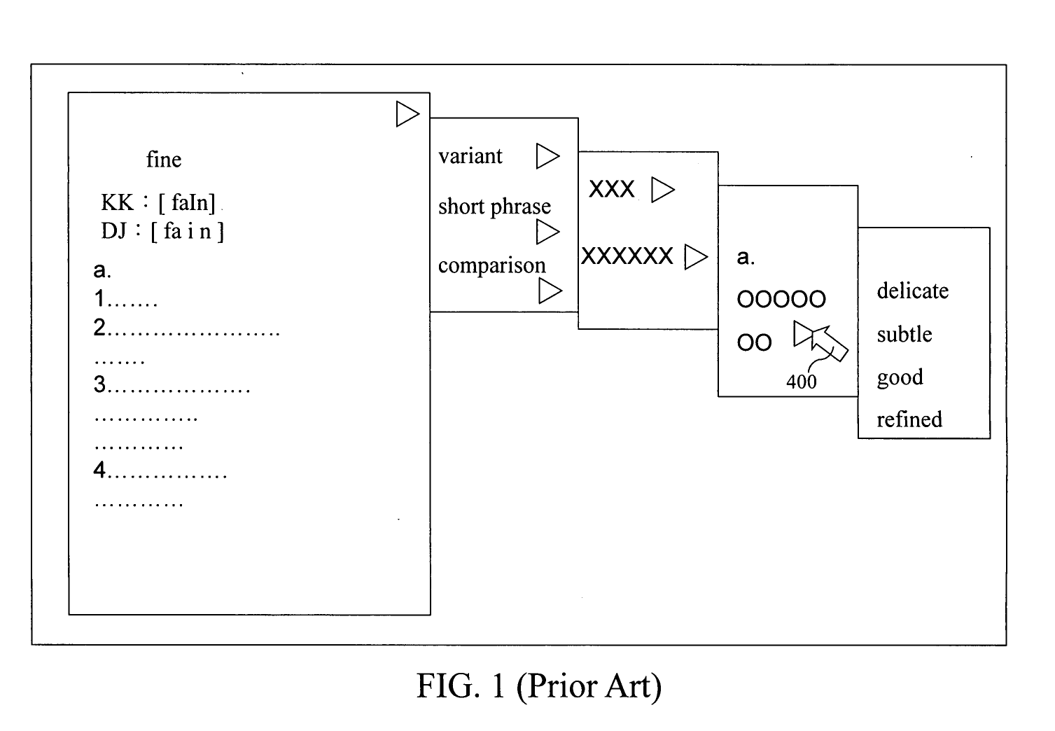

### DETAILED DESCRIPTION OF THE INVENTION

The present invention will be apparent from the following detailed description, which proceeds with reference to the accompanying drawings, wherein the same references relate to the same elements.

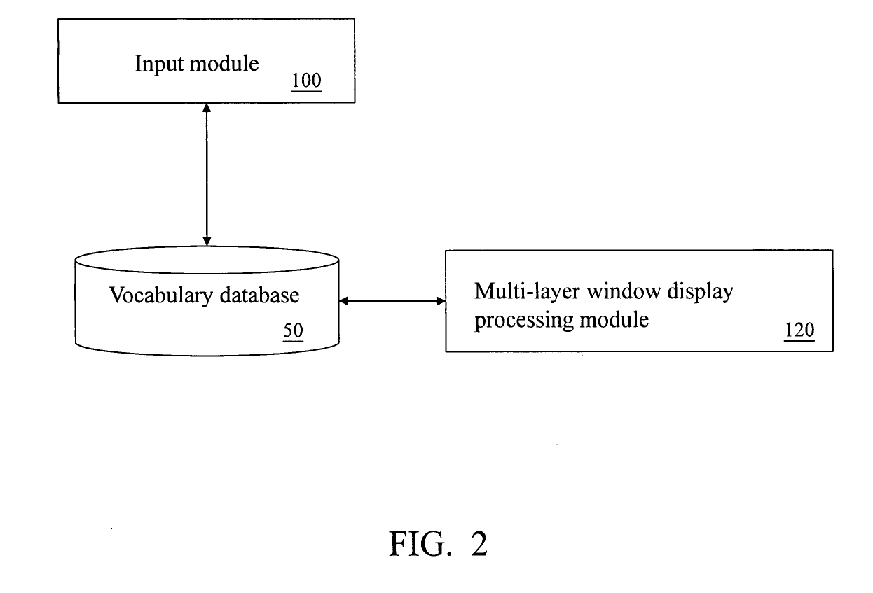

Please refer to FIG. 2, which is a block diagram of the multi-layer window display system for the REAL-TIME TRANSLATION SYSTEM. It includes: a vocabulary database 50, an input module 100, and a multi-layer window display processing module 120.

The vocabulary database 50 stores at least one word and the corresponding at least one layer of contents. The layers here indicate the relations among the contents. Generally speaking, the contents in the next layer are more detailed or related contents of the current layer. In the vocabulary database 50, words with layered or related contents are attributed with the corresponding correlations. After the input module 100 transmits the search word entered by the user, the vocabulary database 50 immediately finds the matched word and outputs at least one layer of contents.

The input module 100 is mainly used to receive a search word entered by the user. The search word is not limited to any particular language. The language is determined by the words and contents (and possibly other contents) in the vocabulary database 50. For example, suppose the words and contents (and possibly other contents) in the vocabulary database 50 are in Chinese-English (i.e., Chinese-to-English real-time translation). The search word acceptable by the input module 100 has to be Chinese. And the translated contents or other contents are then in English (with possibly some parts in Chinese). The invention is not limited to this particular embodiment.

The multi-layer window display processing module 120 is the key module of the invention. When at least one layer of contents transmitted from the vocabulary database 50 is received, the corresponding number of layers of windows are prepared in order to display at least one layer of contents. The first layer of contents is shown in a current window (the current window is always displayed). The contents of the other layers are kept in order in hidden windows. The multi-layer window display processing module 120 further determines whether any other hidden window exists. If there are other hidden windows, the multi-layer window display processing module 120 executes the following procedure iteratively.

First, (a) generate at least one trigger icon for the contents of the next layer in the current window. Then (b) detect the mouse cursor position manipulated by the user. When the mouse cursor position is on one of the trigger icons in the current window, the hidden window of the next layer is triggered in the direction designated by the current window. The hidden window is set as the current window. (c) Check whether there is a next layer of contents. If there is, repeat (a) again.

It should be emphasized that the direction designated by the current window is opposite to that of the previous one. Therefore, the invention makes better use of the limited screen space to display the maximal contents. It is also convenient for the user to browse and operate with minimal mouse tracking motion.

The above-mentioned iteration of the multi-layer window display processing module 120 stops when one of the following situations happens: there is no next layer of contents to display (i.e., no further hidden window); or the user does not move the mouse onto any of the trigger icons.

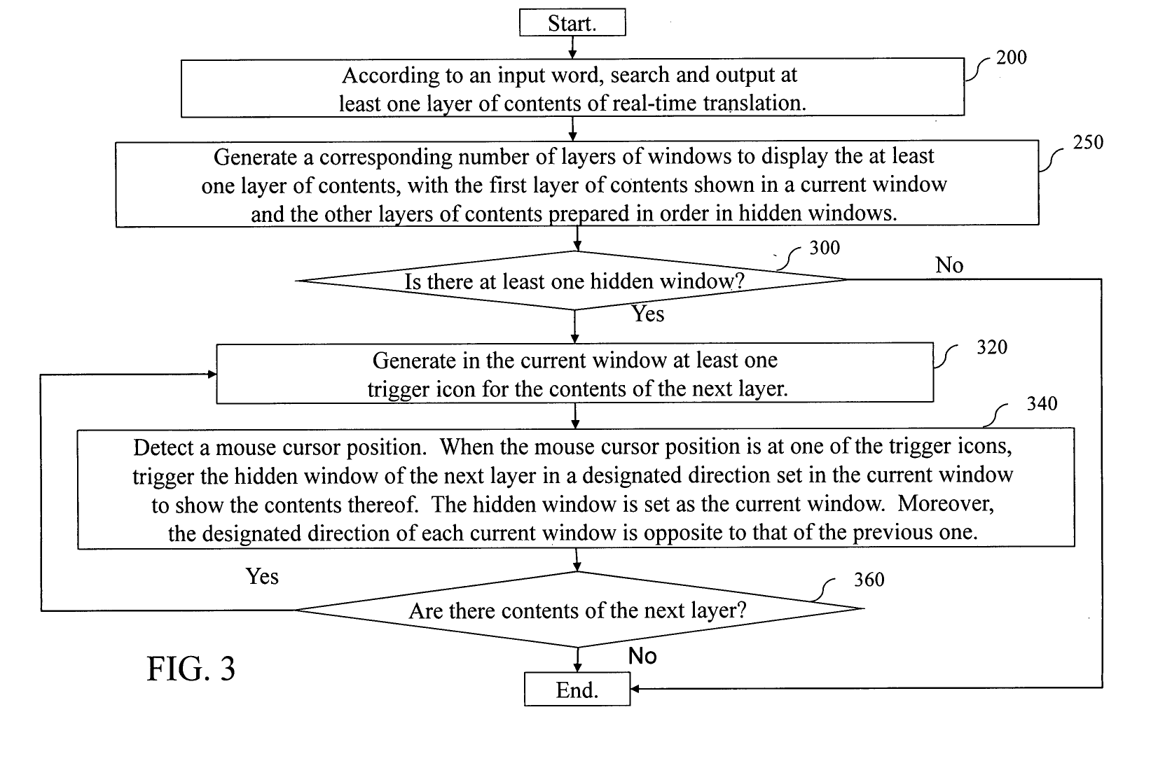

FIG. 3 is a flowchart of the disclosed multi-layer window display method for the REAL-TIME TRANSLATION SYSTEM. The method includes the steps of: receiving a search word entered by the user and searching and outputting at least one layer of contents of the search result (step 200); generating the corresponding number of layers of windows to display at least one layer of contents, with the first layer of contents shown in a current window and the contents of the other layers prepared in other hidden windows (step 250); determining whether any other hidden window exists (step 300). The method requires a mechanism for multi-layer window display. The following steps are executed.

Step 320 generates at least one trigger icon for the contents of the next layer in the current window. This step enables the user to trigger extended contents. The trigger icon is clickable. It should be noted that the trigger icon generally indicates a direction that is the same as the designated direction. It is for the user's reference and for the user to expect which direction the next window is going to be.

Step 340 detects the mouse cursor position manipulated by the user. When the mouse cursor position is on any of the trigger icons, it means that the user wants to further browse other contents. At this moment, the hidden window of the next layer is triggered according to the designated direction set by the current window, showing contents of the next layer. The hidden window now is set as the current window.

After completing step 340, step 360 further checks whether there is a next layer in the current window. If there is, the procedure goes back to step 340. Otherwise, the procedure terminates.

In step 340, the designated direction set by the current window has to opposite to that of the previous one. Therefore, the invention makes better use of the limited screen space to display the maximal contents. It is also convenient for the user to browse and operate with minimal mouse tracking motion.

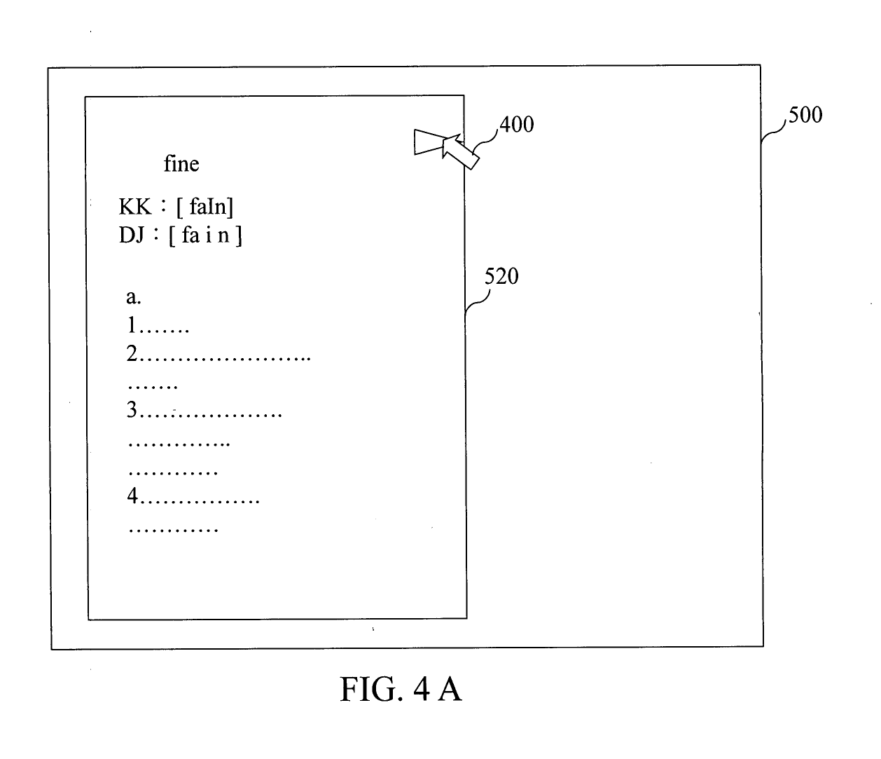

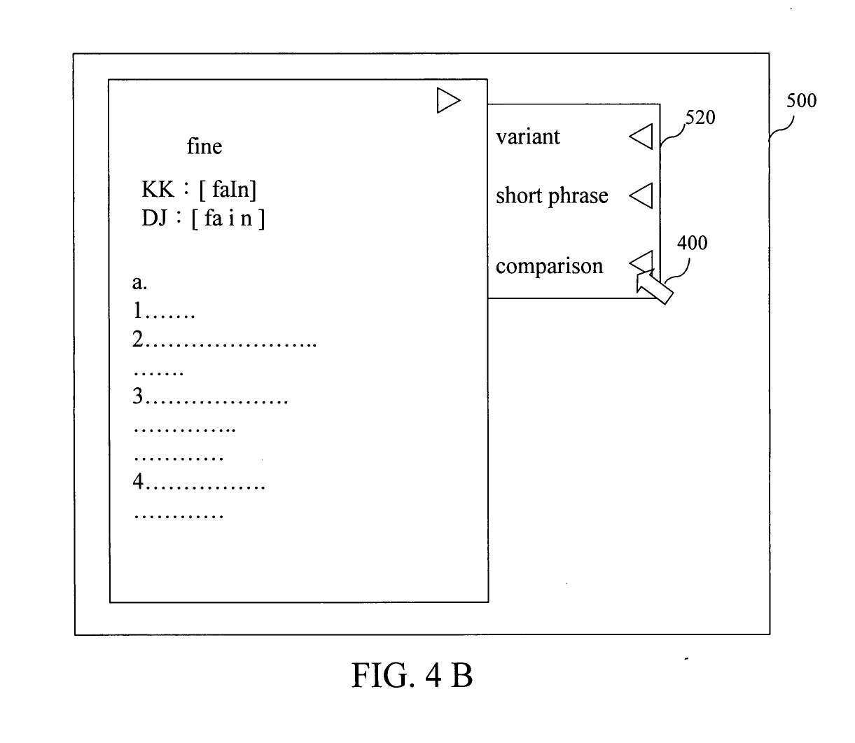

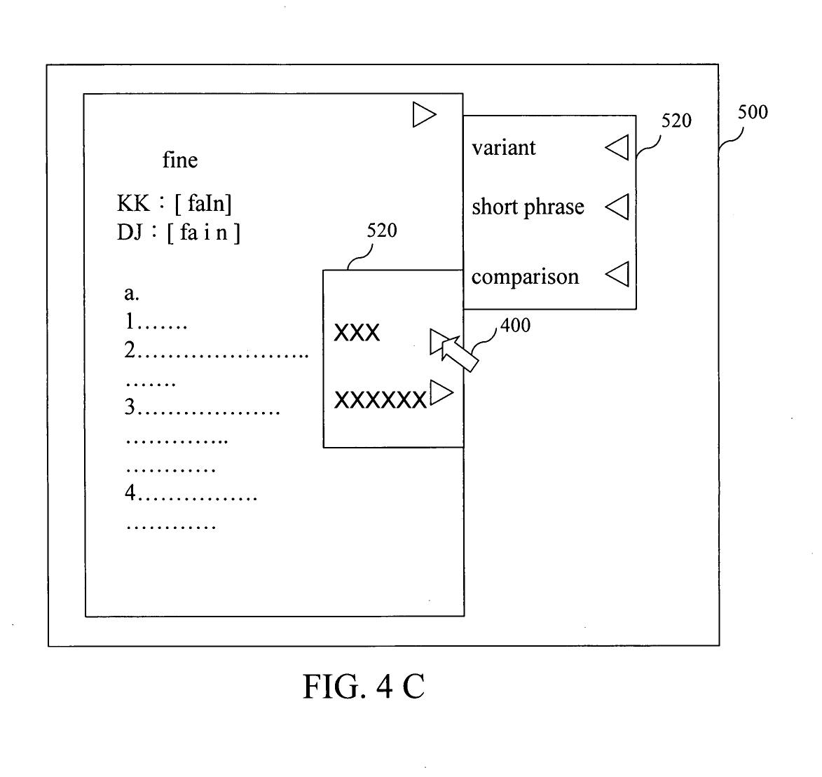

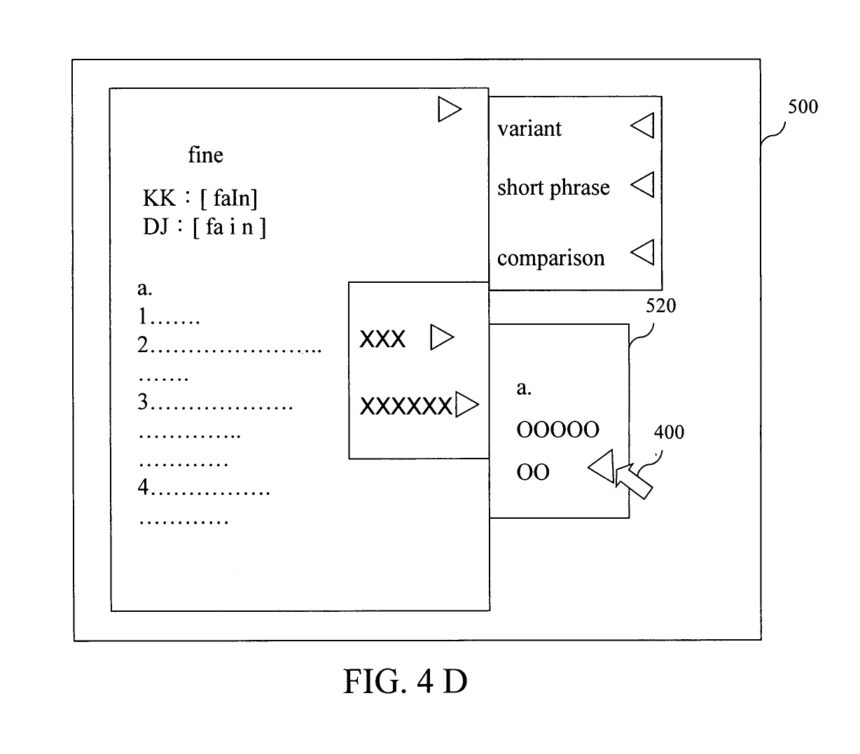

One embodiment is used to illustrate the entire procedure of multi-layer window display with reference to FIGS. 4A to 4D.

In FIG. 4A, the REAL-TIME TRANSLATION SYSTEM translates the search word entered by the user, and generates the current window 250 in the REAL-TIME TRANSLATION SYSTEM interface 500. Since the search word has more than one layer of contents, the current window 520 has a trigger icon, meaning that the contents in the current window 520 have other further contents to show. When the user moves the mouse cursor 400 onto the trigger icon, it further triggers the hidden window of the next layer, as shown in FIG. 4B. The new window (i.e., the triggered hidden window of the next layer) is set as the current window 520. As shown in the drawing, there are three more trigger icons, corresponding to ‘variant’, ‘short phrase’, and ‘comparison’, respectively, for the user to click.

When the mouse cursor 400 falls on the trigger icon of ‘comparison’, the new window (i.e., the hidden window of the next layer) is triggered, as show in FIG. 4C. As noted, the expanding direction (i.e., the designated direction) of the current window (i.e., the hidden window of the next layer) is opposite to the designated direction of the previous current window (of the previous layer). Take FIGS. 4B and 4C as an example. In FIG. 4B, the current window expands to the right of the previous current window. In FIG. 4C, the current window expands to the left of the previous current window (i.e., the current window in FIG. 4B). Therefore, the invention makes better use of the limited screen space to display the maximal contents. It is also convenient for the user to browse and operate with minimal mouse tracking motion. The subsequent expansions are as shown in FIGS. 4B and 4C. Please refer to FIG. 4D. At this moment, the hidden window of the next layer follows FIG. 4C. The designated direction has to be opposite to that in FIG. 4C. That is, it expands to the right of the previous current window (of the previous layer). As long as there are contents of the next layer (hidden window of the next layer) to display, the user can move the mouse cursor onto the trigger icon to expand those windows indefinitely.

In comparison with the prior art, the invention can indeed show more contents in the limited screen. It has less effect on other applications and desktop icons. Moreover, the entire operation is more convenient for the user because it involves minimal mouse tracking motion.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A multi-layer window display method for real-time translation, comprising the steps of:
searching an entered search word and output at least one layer of contents of the real-time translation;
generating the corresponding number of layers of windows for displaying the contents, with the first layer of contents shown in a current window and the contents of the other layers prepared in order in hidden windows; and
when there is at least one hidden window, iteratively executing the steps of:
generating at least one trigger icon for the contents in the next layer in the current window;
detecting a mouse cursor position and, when the mouse cursor position is at one of the trigger icons, triggering the hidden window of the next layer according to a designated direction of the current window to show the contents of the next layer, and setting the hidden window as the current window; and
checking whether there are contents of the next layer;
wherein the designated direction of each current window is opposite to that of the previous current window.

2. The multi-layer window display method for real-time translation of claim 1, wherein the designated direction is right or left.

3. The multi-layer window display method for real-time translation of claim 1, wherein the designated direction is up or down.

4. The multi-layer window display method for real-time translation of claim 1, wherein the step of detecting the mouse cursor position further includes the step of hiding the current window when the mouse cursor position is outside the current window.

5. The multi-layer window display method for real-time translation of claim 1, wherein the trigger icon indicates the direction of the designated direction.

6. A multi-layer window display system for real-time translation, comprising:
an input module for receiving a search word;
a vocabulary database for storing at least one word and the corresponding at least one layer of contents, searching the search word, and outputting at least one layer of contents of the real-time translation; and
a multi-layer window display processing module for generating a corresponding number of layers of windows to display at least one layer of contents when the at least one layer of contents is received, with the first layer of contents shown in a current window and the contents of the other layers prepared in hidden windows;
wherein when there is at least one hidden window, the system iteratively executes the steps of:
generating at least one trigger icon for the contents in the next layer in the current window;
detecting a mouse cursor position and, when the mouse cursor position is at one of the trigger icons, triggering the hidden window of the next layer according to a designated direction of the current window to show the contents of the next layer, and setting the hidden window as the current window; and
checking whether there are contents of the next layer;
wherein the designated direction of each current window is opposite to that of the previous current window.

7. The multi-layer window display system for real-time translation of claim 6, wherein the designated direction is right or left.

8. The multi-layer window display system for real-time translation of claim 6, wherein the designated direction is up or down.

9. The multi-layer window display system for real-time translation of claim 6, wherein the multi-layer window display processing module detects the mouse cursor position and hides the current window when the mouse cursor position is outside the current window.

10. The multi-layer window display system for real-time translation of claim 6, wherein the trigger icon indicates the direction of the designated direction.
